(19) United States
(12) Patent Application Publication
(10) Pub. No.: US 2006/0277524 A1
(43) Pub. Date: Dec. 7, 2006

(54) Redundant updatable firmware in a distributed control system

(75) Inventor: Brian G. Goodman, Tucson, AZ (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/146,967

(22) Filed: Jun. 7, 2005

(51) Int. Cl. G06F 9/44

(52) U.S. Cl. 717/106

(57) ABSTRACT

A redundant firmware update of a processor node in a distributed control system involves the storage of a first primary code image in a first memory space and a first backup code image in a second memory space prior to receiving an electrical communication of a second primary code image as an update of the first primary code image. In response to receiving the electrical communication of the second primary code image as an update of the first primary code image, the second primary code image is stored in the second memory space and a second backup code image is subsequently stored in the first memory space.

### FIELD OF INVENTION

This invention relates to a distributed system of modules, and, more specifically, to at least a plurality of the modules having associated processor nodes interconnected in a network, the processor nodes having code for operating the associated module.

### BACKGROUND OF THE INVENTION

Distributed systems may comprise a plurality of modules, at least some of which have associated processor nodes interconnected in a network. The processor nodes typically comprise a processing unit for operating the associated module and a processor interface for providing communication of the processor node in the network. The processing unit executes code, such as computer readable program code, which may be stored in memory, such as a nonvolatile memory, in order to operate the associated module. The modules and associated processors may be termed embedded systems.

An example of a distributed system comprises an automated data storage library which stores removable data storage media in storage shelves, and has at least one data storage drive to read and/or write data on the removable data storage media. An accessor robot transports the removable data storage media, which may be in the form of cartridges, between the data storage drives and the storage shelves. An operator panel allows an operator to communicate with the library, the operator panel also sensing other interaction with the library, such as opening a door and inserting or removing cartridges from the library. Also, a controller controls host interaction with the library, which may include interaction between the host and the data storage drives.

In the example of an IBM 3584 UltraScalable Tape Library, two processor nodes are provided for the accessor robot modules, an accessor controller controls basic accessor functions including cartridge handling by a gripper, accessor work queuing, reading cartridge labels, etc., and an XY controller controls the X and Y motion of the accessor robot. An operator panel controller processor node controls basic operator panel module functions including display output, keyboard input, I/O station sensors and locks, etc. A medium changer controller processor node controls controller module functions including host interaction, including host communications, drive communication, “Ethernet” communications, power management, etc. The processor nodes are interconnected by an network, such as a CAN (Controller Area Network), which comprises a multi-drop network. Other accessor robot modules, and operator station modules may be added, each with the associated processor nodes.

An issue to be addressed is that of backup code, or code that may be employed by a processor node that needs to restore its code image. For example, the code image for one of the processor nodes may become compromised in some way during operation, the code image utilized by a processor node may be partially erased, the module may be replaced and the processor node code image is incorrect, or a processor of a node may be unavailable, such as from the network, when one or more of the other processor nodes are updated. The processor node may then enter an error state, which may require operator intervention. A backup copy of the code must then be located and utilized to restore the functioning of the module of the erroneous processor node. The operator may select a complete code image, comprising the code for all of the processor nodes, from another processor node, or may select a master code image from a master nonvolatile store, but must first be assured that the code image is correct and can serve as a system backup. Impediments to utilizing a complete code image duplicated at each processor node, or at a master source, are the requirement for nonvolatile memory for the full amount of code, and the need to update the complete or master code image even when only the code for one processor node module is actually updated. In the event there are different levels of complete code at different processor nodes, a down level complete code at one processor node may not be correct or may not be serviceable as a potential backup for another processor node.

### SUMMARY OF THE INVENTION

The aforementioned need is addressed by a redundant firmware update method for a distributed control system as disclosed in coassigned U.S. Patent Application Publication No. 2004/0139294 A1, filed Jan. 14, 2003, and published Jul. 15, 2004. The present invention enhances the known redundant firmware update method for a distributed control system by providing a new and unique redundant firmware update method that better utilizes memory space required to implement the method.

One form of the present invention is signal bearing medium tangibly embodying a program of machine-readable instructions executable by a processor to perform operations for a redundant firmware update of a processor node in a distributed control system. The operations comprise storing a first primary code image in a first memory space and a first backup code image in a second memory space prior to receiving an electrical communication of a second primary code image as an update of the first primary code image, and storing a second backup code image in the first memory space and a second primary code image in the second memory space in response to receiving the electrical communication of the second primary code image as the update of the first primary code image and receiving an electrical communication of the second backup code image, wherein the second primary code image is written into the second memory space prior to the second backup code image being written into the first memory space.

A second form of the present invention is a processor node in a distributed control system, the processor node comprising a processor and a memory operable to store instructions operable with the processor for a redundant firmware update of the processor node in the distributed control system. The instructions being executable for storing a first primary code image in a first memory space and a first backup code image in a second memory space prior to receiving an electrical communication of a second primary code image as an update of the first primary code image, and storing a second backup code image in the first memory space and a second primary code image in the second memory space in response to receiving the electrical communication of the second primary code image as the update of the first primary code image and receiving an electrical communication of the second backup code image, wherein the second primary code image is written into the second memory space prior to the second backup code image being written into the first memory space.

A third form of the present invention is method for a redundant firmware update of the processor node in the distributed control system. The method comprises storing a first primary code image in a first memory space and a first backup code image in a second memory space prior to receiving an electrical communication of a second primary code image as an update of the first primary code image, and storing a second backup code image in the first memory space and a second primary code image in the second memory space in response to receiving the electrical communication of the second primary code image as the update of the first primary code image and receiving an electrical communication of the second backup code image, wherein the second primary code image is written into the second memory space prior to the second backup code image being written into the first memory space.

The forgoing forms and other forms, objects, and aspects as well as features and advantages of the present invention will become further apparent from the following detailed description of the various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is an isometric view of an automated data storage library adaptable to implement an embodiment of the present invention, with the view specifically depicting a library having a left hand service bay, multiple storage frames and a right hand service bay;

FIG. 2 is an isometric view of an automated data storage library adaptable to implement an embodiment of the present invention, with the view specifically depicting an exemplary basic configuration of the internal components of a library;

FIG. 3 is a block diagram of an automated data storage library adaptable to implement an embodiment of the present invention, with the diagram specifically depicting a library that employs a distributed system of modules with a plurality of processor nodes;

FIG. 4 is a block diagram depicting an exemplary controller configuration;

FIG. 5 is an isometric view of the front and rear of a data storage drive adaptable to implement an embodiment of the present invention;

FIG. 6 is an isometric view of a data storage cartridge adaptable to implement an embodiment of the present invention;

FIG. 7 illustrates a flowchart representative of an exemplary embodiment of a redundant firmware update method in accordance with the present invention;

FIGS. 8A-8C illustrates an exemplary execution of the FIG. 7 flowchart in accordance with the present invention;

FIG. 9 illustrates a flowchart representative of an exemplary embodiment of a firmware update file broadcast method in accordance with the present invention;

FIGS. 10A-10F illustrate exemplary memory states of flash PROMS in a backup pairing arrangement prior to an execution of the FIG. 9 flowchart in accordance with the present invention;

FIGS. 10A-11D illustrate exemplary firmware update files in accordance with the present invention for updating the flash PROMS illustrated FIGS. 10A-10F;

FIGS. 12A-12F illustrate exemplary memory states of the flash PROMS illustrated FIGS. 10A-10F after an execution of the FIG. 9 flowchart in accordance with the present invention;

FIGS. 13A-13F illustrate exemplary memory states of flash PROMS in a backup shifting arrangement prior to an execution of the FIG. 9 flowchart in accordance with the present invention;

FIGS. 14A and 14B illustrate exemplary firmware update files in accordance with the present invention for updating the flash PROMS illustrated FIGS. 13A-13F; and

FIGS. 15A-15F illustrate exemplary memory states of the flash PROMS illustrated FIGS. 13A-13F after an execution of the FIG. 9 flowchart in accordance with the present invention.

### DETAILED DESCRIPTION OF THE INVENTION

This invention is described in preferred embodiments in the following description with reference to the Figures, in which like numerals represent the same or similar elements. While this invention is described in terms of the best mode for achieving this invention's objectives, it will be appreciated by those skilled in the art that it is intended to cover alternatives, modifications, and equivalents as may be included within the spirit and scope of the invention as defined by the appended claims.

The invention will be described as embodied in an automated magnetic tape library storage system for use in a data processing environment. Although the invention shown uses magnetic tape cartridges, one skilled in the art will recognize the invention equally applies to optical disk cartridges or other removable storage media and the use of either different types of cartridges or cartridges of the same type having different characteristics. Furthermore the description of an automated magnetic tape storage system is not meant to limit the invention to magnetic tape data processing applications as the invention herein can be applied to any media storage and cartridge handling systems in general. Still further, the invention may be used in any system that comprises modules or processors connected together through one or more networks.

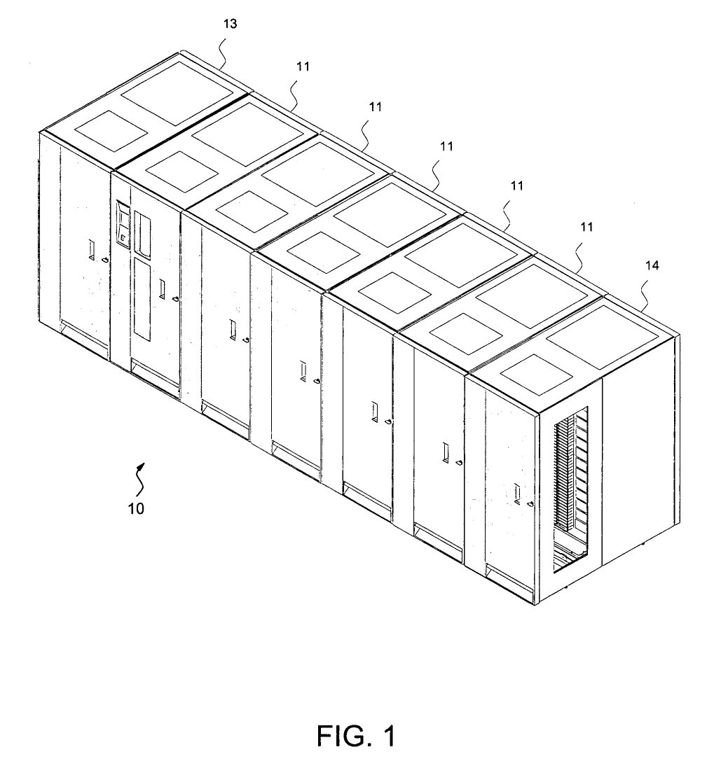

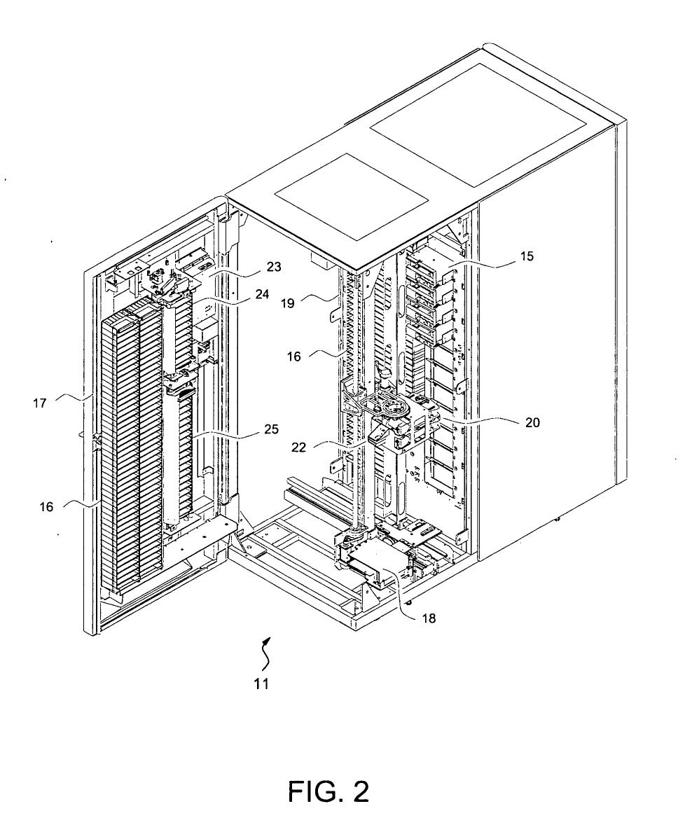

Turning now to the Figures, FIGS. 1 and 2 illustrate an automated data storage library 10 which stores and retrieves data storage cartridges containing data storage media (not shown) in storage shelves 16. It is noted that references to “data storage media” herein refer to data storage cartridges, and for purposes herein the two terms are used synonymously. An example of an automated data storage library which may implement the present invention, and has a configuration as depicted in FIGS. 1 and 2, is the IBM 3584 UltraScalable Tape Library. The library of FIG. 1 comprises a left hand service bay 13, one or more storage frames 11, and right hand service bay 14. As will be discussed, a frame may comprise an expansion component of the library. Frames may be added or removed to expand or reduce the size and/or functionality of the library. Frames may comprise additional storage shelves, drives, import/export stations, accessors, operator panels, etc.

FIG. 2 shows an example of a storage frame 11, which is the base frame of the library 10 and is contemplated to be the minimum configuration of the library. In this minimum configuration, there is only a single accessor (i.e., there are no redundant accessors) and there is no service bay. The library 10 is arranged for accessing data storage media in response to commands from at least one external host system (not shown), and comprises a plurality of storage shelves 16, on front wall 17 and rear wall 19 for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The data storage drives 15 may be optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18.

As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or other reading system, such as a cartridge memory reader or similar system, mounted on the gripper 20, to “read” identifying information about the data storage media.

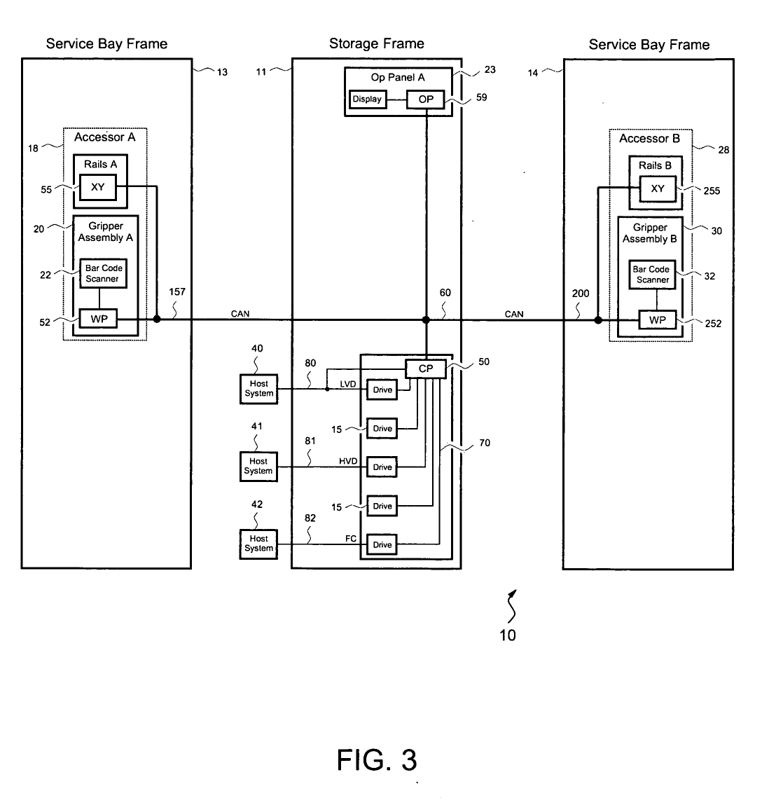

FIG. 3 illustrates an embodiment of an automated data storage library 10 of FIGS. 1 and 2, which employs a distributed system of modules with a plurality of processor nodes. An example of an automated data storage library which may implement the distributed system depicted in the block diagram of FIG. 3, and which may implement the present invention, is the IBM 3584 UltraScalable Tape Library. For a fuller understanding of a distributed control system incorporated in an automated data storage library, refer to U.S. Pat. No. 6,356,803, which is entitled “Automated Data Storage Library Distributed Control System,” which is incorporated herein for reference.

While the automated data storage library 10 has been described as employing a distributed control system, the present invention may be implemented in automated data storage libraries regardless of control configuration, such as, but not limited to, an automated data storage library having two or more library controllers that are not distributed, as that term is defined in U.S. Pat. No. 6,356,803. The library of FIG. 3 comprises one or more storage frames 11, a left hand service bay 13 and a right hand service bay 14. The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media. The terms “commands” and “work requests” are used interchangeably herein to refer to such communications from the host system 40, 41 or 42 to the library 10 as are intended to result in accessing particular data storage media within the library 10.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80. The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, host connections 80 and 81 are SCSI busses. Bus 82 comprises an example of a Fibre Channel bus which is a high speed serial data interface, allowing transmission over greater distances than the SCSI bus systems.

While the automated data storage library 10 is described as employing a distributed control system, the present invention may be implemented in various automated data storage libraries regardless of control configuration, such as, but not limited to, an automated data storage library having two or more library controllers that are not distributed. A library controller may comprise one or more dedicated controllers of a prior art library or it may comprise one or more processor nodes of a distributed control system. Herein, library controller may comprise a single processor or controller or it may comprise multiple processors or controllers.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network. Additional storage frames 11 may be provided and each is coupled to the adjacent storage frame. Any of the storage frames 11 may comprise communication processor nodes 50, storage shelves 16, data storage drives 15, and networks 60.

Further, as described above, the automated data storage library 10 may comprise a plurality of accessors. A second accessor 28, for example, is shown in a right hand service bay 14 of FIG. 3. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 3 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

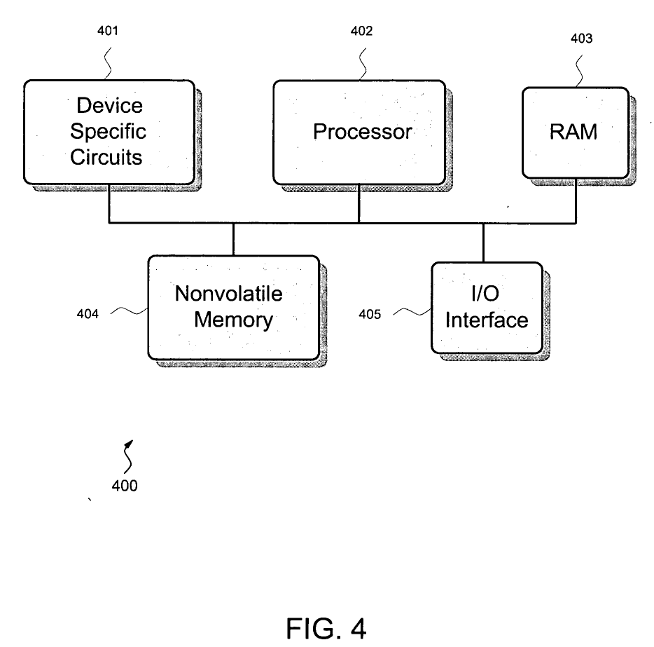

An automated data storage library 10 typically comprises one or more controllers to direct the operation of the automated data storage library. Host computers and data storage drives typically comprise similar controllers. A controller may take many different forms and may comprise, for example but not limited to, an embedded system, a distributed control system, a personal computer, or a workstation, etc. In another example, one of the processor nodes 50, 52, 55, 59, 252, 255 may comprise a controller. Still further, two or more of the processor nodes may comprise a controller. In this example, the controller may be distributed among the two or more processor nodes. Essentially, the term “controller” as used herein is intended in its broadest sense as a device or system that contains at least one processor, as such term is defined herein. FIG. 4 shows a typical controller 400 with a processor 402, RAM (Random Access Memory) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, FPGA (Field Programmable Gate Array), ASIC (Application Specific Integrated Circuit), discrete logic, or the like. The RAM (Random Access Memory) 403 is typically used to hold variable data, stack data, executable instructions, and the like. The nonvolatile memory 404 may comprise any type of nonvolatile memory such as, but not limited to, EEPROM (Electrically Erasable Programmable Read Only Memory), flash PROM (Programmable Read Only Memory), MRAM (Magnetoresistive Random Access Memory), battery backup RAM, hard disk drives, etc. The nonvolatile memory 404 is typically used to hold the executable firmware and any nonvolatile data. The I/O interface 405 comprises a communication interface that allows the processor 402 to communicate with devices external to the controller. Examples may comprise, but are not limited to, serial interfaces such as RS-232, USB (Universal Serial Bus), Fibre Channel, SCSI (Small Computer Systems Interface), etc. The device specific circuits 401 provide additional hardware to enable the controller 400 to perform unique functions such as, but not limited to, motor control of a cartridge gripper. The device specific circuits 401 may comprise electronics that provide, by way of example but not limitation, Pulse Width Modulation (PWM) control, Analog to Digital Conversion (ADC), Digital to Analog Conversion (DAC), etc. In addition, all or part of the device specific circuits 401 may reside outside the controller 400.

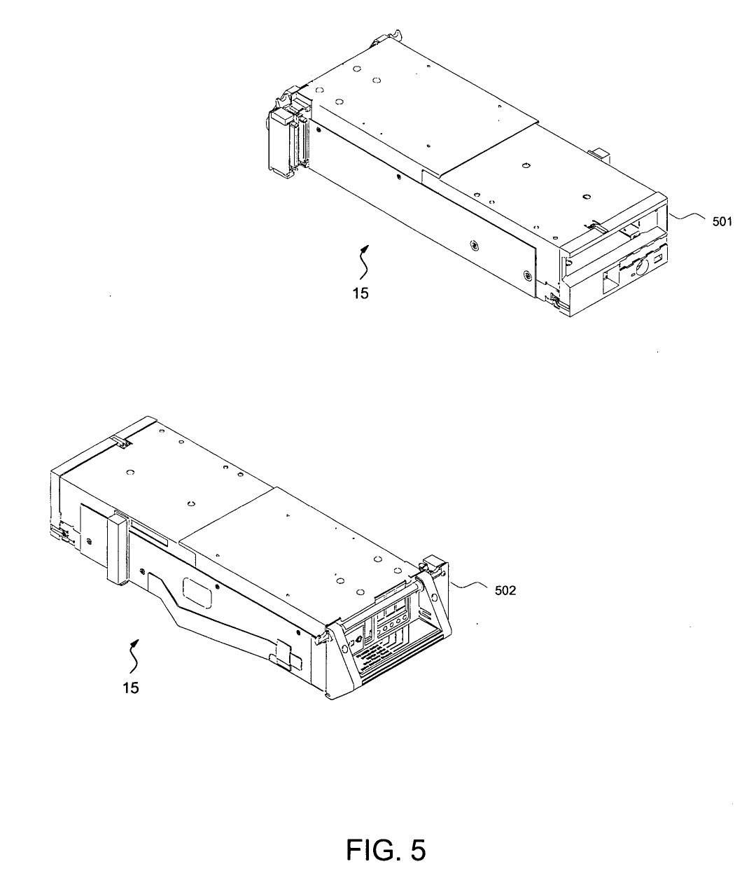

FIG. 5 illustrates an embodiment of the front 501 and rear 502 of a data storage drive 15. In the example of FIG. 5, the data storage drive 15 comprises a hot-swap drive canister. This is only an example and is not meant to limit the invention to hot-swap drive canisters. In fact, any configuration of data storage drive may be used whether or not it comprises a hot-swap canister.

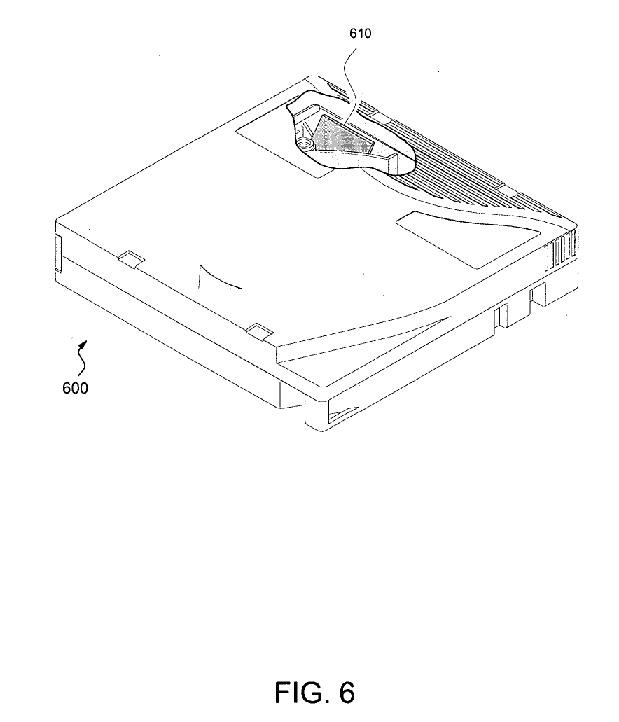

FIG. 6 illustrates an embodiment of a data storage cartridge 600 with a cartridge memory 610 shown in a cutaway portion of the Figure. This is only an example and is not meant to limit the invention to cartridge memories. In fact, any configuration of data storage cartridge may be used whether or not it comprises a cartridge memory.

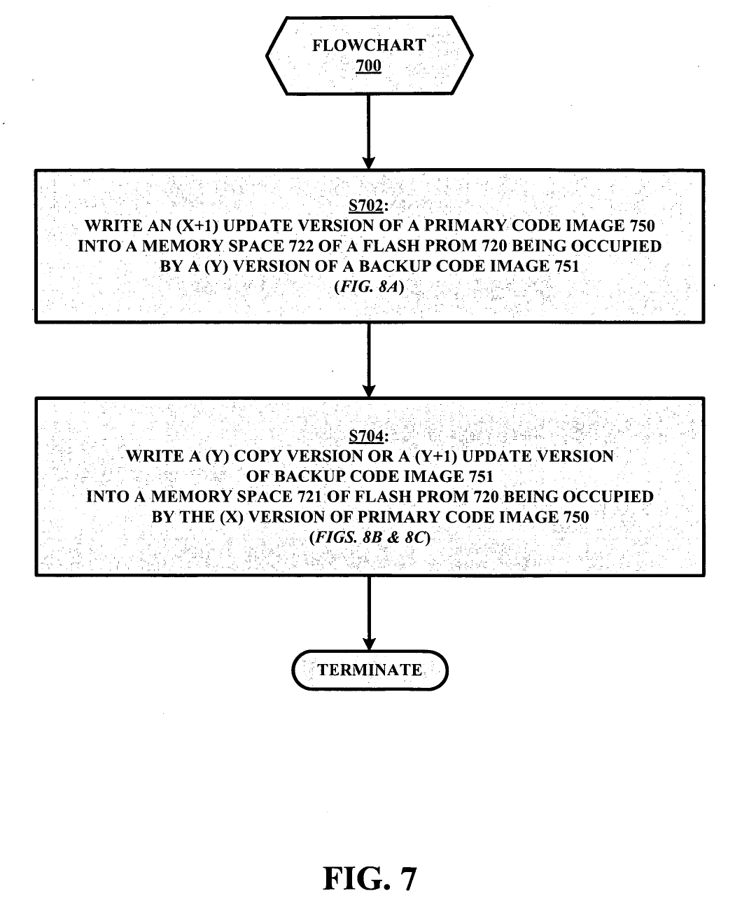

FIG. 7 illustrates a flowchart 700 representative of a redundant firmware update method of the present invention. Firmware update refers to the process of loading firmware on a controller. The firmware being loaded may comprise an earlier version of firmware, a later version of firmware, or the same version of firmware that is already loaded on the controller. The description of Flowchart 700 is based on a non-volatile memory of each processor node of a distributed control system (e.g., nodes 50, 52, 55, 59, 252 and 255 shown in FIG. 3) whereby the non-volatile memory of each processor node (e.g., non-volatile memory 404 shown in FIG. 4) stores a primary code image for operating the subject processor node and a backup code image for operating another processor node of the distributed control system. Flowchart 700 is described as using a single nonvolatile memory for storing a primary code image and a backup code image. This is done to simplify the description of the present invention and is not meant to limit the present invention to a single nonvolatile device. In fact, the primary code image and the backup code image could be stored in different nonvolatile memories. In addition, multiple nonvolatile memories could be used to store the primary code image and/or the backup code image. Herein, references to “nonvolatile memory” may refer to the same memory, or it may refer to multiple memories.

In one embodiment, instructions for implementing flowchart 700 are stored within a non-updatable memory space of the non-volatile memory of the processor node whereby the instructions can be loaded within a volatile memory of the processor node (e.g., RAM 403 shown in FIG. 4) to thereby be executed by a processor of the processor node (e.g., processor 402 shown in FIG. 4). In an alternative embodiment, instructions for implementing flowchart 700 are embedded within each version of the primary code image whereby the coded instructions can be loaded within a volatile memory of the processor node from a primary code image stored in the non-volatile memory of the processor node to thereby be executed by the processor of the processor node. Still further, the instructions may be executed directly out of a nonvolatile memory.

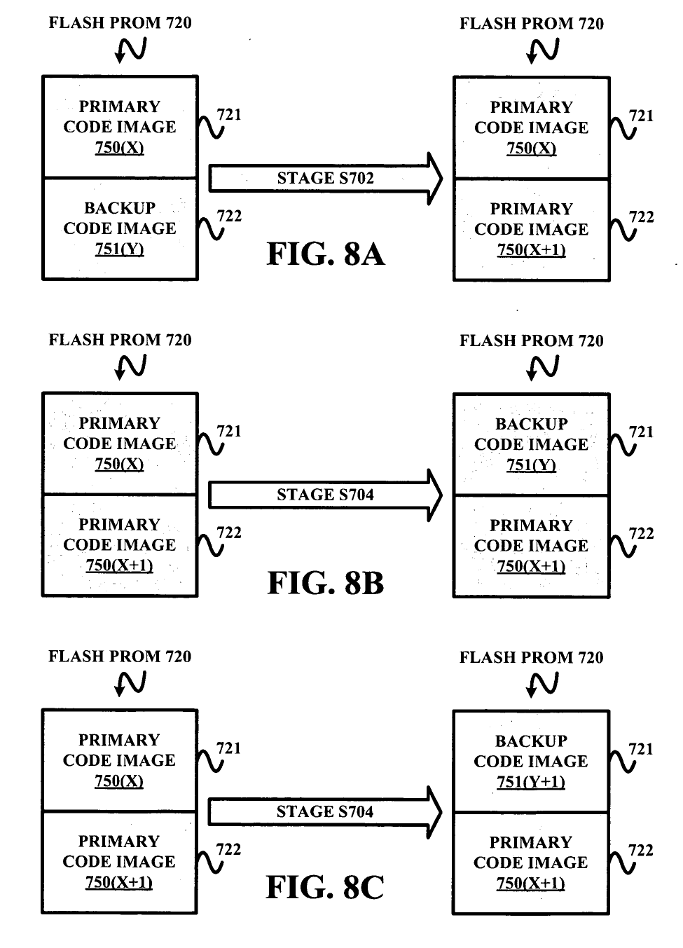

To facilitate an understanding of the redundant firm update method of the present invention, flowchart 700 is described in the context of the processor node employing a non-volatile memory in the form of a flash prom 720 as shown in FIG. 8A that is storing, prior to an implementation of flowchart 700, an (X) version of a primary code image 750 within a memory space 721 of flash prom 720 and a (Y) version of a backup code image 751 within a memory space 722 of flash prom 720. Nonetheless, from the description of FIG. 7, those having ordinary skill in the art will appreciate how to apply flowchart 700 to other forms of non-volatile memories employed within processor nodes of a distributed control system. Furthermore, those having ordinary skill in the art will appreciate how to broaden the scope of flowchart 700 to apply to processor nodes storing backup copy images for two or more other processor nodes in the distributed control system.

Referring to FIG. 7, a stage S702 of flowchart 700 encompasses the processor writing an (X+1) update version of primary code image 750 into memory space 722, which was previously occupied by the (Y) version of backup code image 751 as shown in FIG. 8A. The backup code image 751 with version (Y) in memory space 722 is first overwritten with the new primary code image 750 with version (X+1) in order to preserve the current state of the primary code image 750 with version (X) in memory space 721. This is an important aspect of the present invention, because if something were to go wrong with the firmware update, then flash prom 720 would still contain a valid working primary code image 750 with version (X) at location 721. On the other hand, if the primary code image 750 with version (X) at location 721 was first updated with either the new primary code image (X+1) or the backup code image (Y or Y+1), and the firmware update was disrupted prior to completing the erase and rewrite of location 721, then the node card would become inoperable and would require human intervention or repair. It should be noted that X+1 and/or Y+1 represents a firmware update and does not necessarily have any bearing on firmware versions before and after the update, as described above.

Upon a successful execution of stage S702, a stage S704 of flowchart 700 encompasses the processor node writing a (Y) copy version of backup code image 751 into memory space 721, which was previously occupied by the (X) version of primary code image 750 as shown in FIG. 8B, or the processor alternatively writing a (Y+1) update version of backup code image 751 into memory space 721, which was previously occupied by the (X) version of primary code image 750 as shown in FIG. 8C. The deciding factor as to whether the (Y) copy version or the (Y+1) update version of backup code image 751 is involved in stage S704 is solely dependent upon whether primary code image 750 is being updated without an update to backup code image 751 during a library firmware update of the distributed control system whereby the (Y) copy version of backup code image 751 is written to memory space 721 during stage S704, or both primary code image 750 and backup code image 751 are being updated during the library firmware update of the distributed control system whereby the (Y+1) update version of backup code image 751 is written to memory space 721 during stage S704.

Referring to FIG. 8, those having ordinary skill in the art will appreciate the fact that a size of the (X) version of primary code image 750 and a size of the (X+1) version of primary code image 750 may or may not be equal. Similarly, a size of the (Y) version of backup code image 751 and a size of the (X+1) version of primary code image 750 may or may not be equal. This fact is not detrimental to the present invention as long as a clear distinction always exists between the two memory spaces within flash PROM 720. In practice, those having ordinary skill in the art will appreciate how to establish and maintain a clear distinction between memory spaces of a non-volatile memory (e.g., flash prom 720) in the context of the present invention.

Referring to FIG. 7, the processor node implements stage S702 of flowchart 700 in response to the processor node receiving an electrical communication of the (X+1) update version of primary code image 750. The processor node can receive an electrical communication of the (Y) copy version or the (Y+1) update version of backup code image 751 prior to or subsequent to receiving the electrical communication of the (X+1) update version of primary code image 750. However, in either case, the processor node will not implement stage S704 of flowchart 700 until after a successful completion of stage S702. This is to ensure that there is always a valid primary code image 750 in the event of a disruption to the firmware update process, as described above.

An electrical communication may comprise any communication method such as, but not limited to, electrical conductors, magnetic induction, radio frequency, infrared or visible light, combinations thereof, etc. In addition, an electrical communication may comprise hardware and/or software protocols such as, but not limited to, proprietary protocols, Ethernet, RS-232 (Recommended Standard), SCSI (Small Computer Systems Interface), Fibre Channel, USB (Universal Serial Bus), Firewire, CAN (Controller Area Network), TCP/IP, etc. Thus, for purposes of the present invention, the term “electrical communication” or any derivate thereof comprises any communication method known to those of ordinary skill in the art, and it may comprise any hardware and/or software protocol known to those of ordinary skill in art.

In one embodiment of flowchart 700, the processor node is prohibited from receiving the electrical communication of the (Y) copy version or the (Y+1) update version of backup code image 751 prior to receiving the electrical communication of the (X+1) update version of primary code image 750. In an alternative embodiment of flowchart 700, the processor node is prohibited from receiving the electrical communication of the (Y) copy version or the (Y+1) update version of backup code image 751 prior to the (X+1) update version of primary code image 750 being written to memory space 722 of flash PROM 720. The act of prohibiting the reception of the electrical communication may comprise a prohibition of the node sending the code image, or it may comprise a prohibition of the node receiving the code image. For example, a receiving node may ignore any data associated with an update to its backup code image if it has not already received and/or updated its primary code image. Herein, prohibiting the reception of the electrical communication may refer to enforcement by either the sending entity, the receiving entity, or combinations thereof.

Still referring to FIG. 7, those having ordinary skill in the art will appreciate the various advantages of the redundant firmware update method of the present invention. In particular, the advantage of maintaining a completely functional processor node during an update of the primary code of the processor node while efficiently using the memory space of the non-volatile memory of the processor node. The efficient use of the memory comes from the fact that the backup image 751 doubles as both a memory for a failsafe firmware update as well as a memory for holding a backup copy of code for another node in the system.

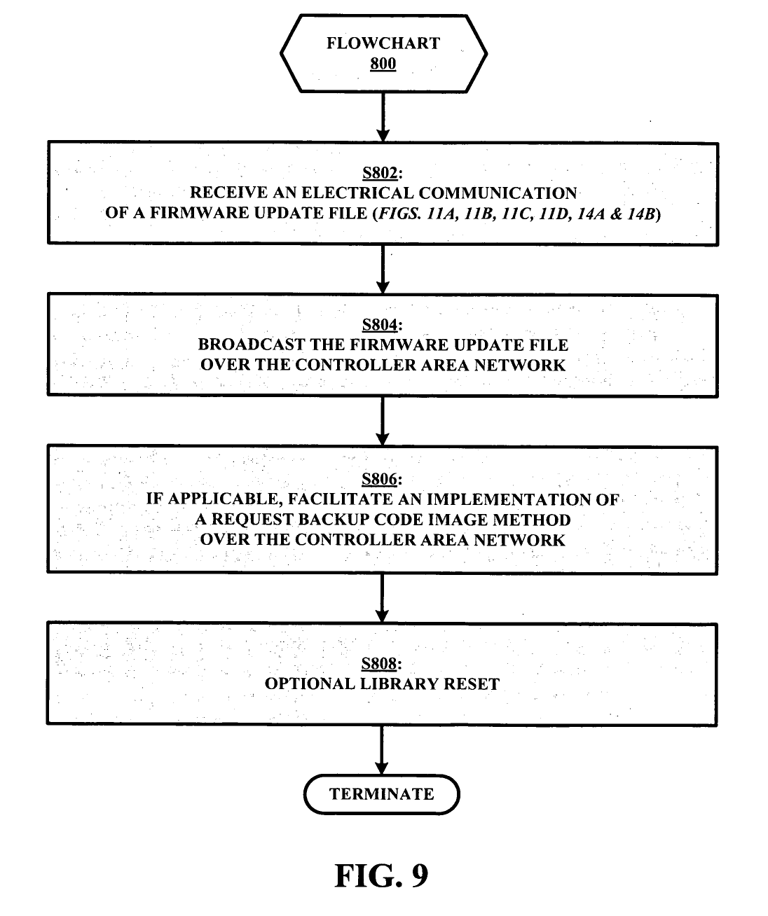

In practice, the present invention does not impose any limitations or any restrictions to the manner by which update versions of primary code images are electrically communicated to the various processor nodes. Thus, the following description of flowchart 800, which is representative of a firmware update file broadcast method of the present invention as illustrated in FIG. 9, does not limit or restrict the scope by which update versions of primary code images are electrically communicated to the various processor nodes. In particular, the primary and/or backup code versions will be described herein as being broadcast to one or more nodes in the system for purposes of simplifying the description of flowchart 800, which is not limited to any particular method of dispatching the code images on a communications interface, either directed or broadcast. Herein, broadcasting a firmware image may comprise directing the transmission of the code image to a single node, or it may comprise broadcasting the code image to two or more nodes, or it may comprise combinations thereof.

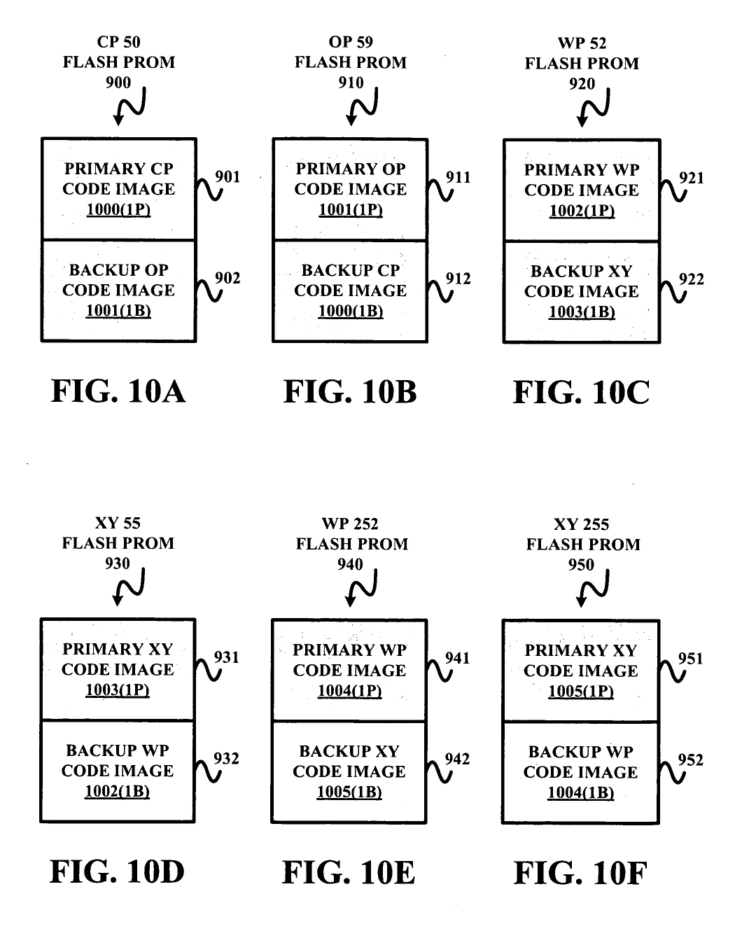

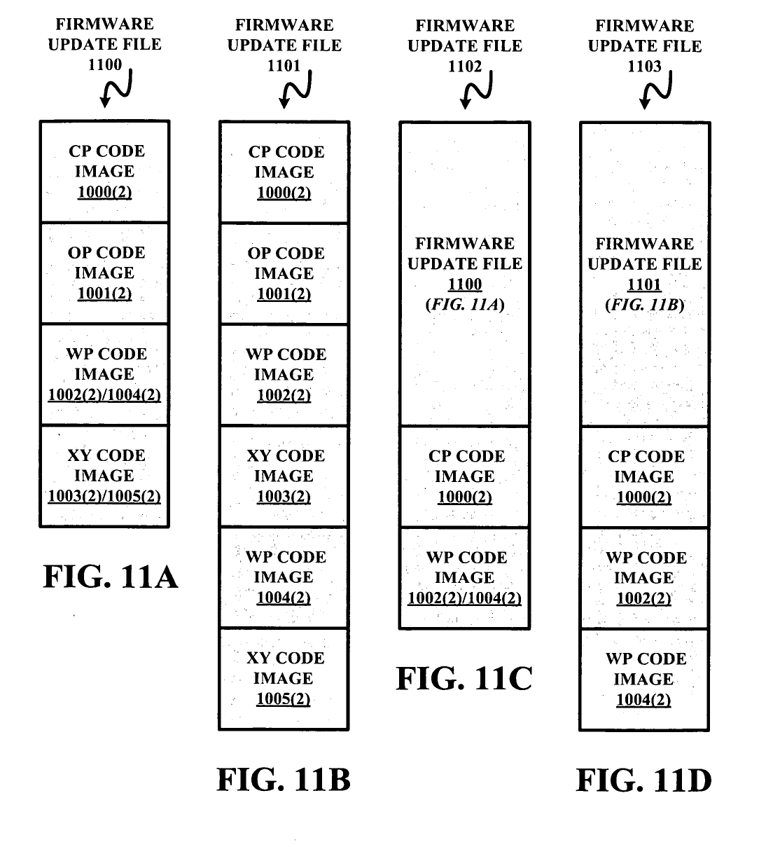

To facilitate an understanding of the firmware update file broadcast method of the present invention, flowchart 800 is initially described in the context of a backup pairing arrangement of nodes 50, 52, 59, 55, 252 and 255 as illustrated in FIGS. 10A-10F storing a CP code image 1000(1), an OP code image 1001(1), a WP code image 1002(1), an XY code image 1003(1), a WP code image 1004(1) and an XY code image 1005(1) prior to the execution of flowchart 800.

As illustrated in FIG. 10A, CP node 50 has a flash PROM 900 storing a primary CP code image 1000(1P) in a memory space 901 and storing a backup OP code image 1001(1B) in a memory space 902.

As illustrated in FIG. 10B, OP node 59 has a flash PROM 910 storing a primary OP code image 1001(1P) in a memory space 911 and storing a backup CP code image 1000(1B) in a memory space 912.

As illustrated in FIG. 10C, WP node 52 has a flash PROM 920 storing a primary WP code image 1002(1P) in a memory space 921 and storing a backup XY code image 1003(1B) in a memory space 922.

As illustrated in FIG. 10D, XY node 55 has a flash PROM 930 storing a primary XY code image 1003(1P) in a memory space 931 and storing a backup WP code image 1002(1B) in a memory space 932.

As illustrated in FIG. 10E, WP node 252 has a flash PROM 940 storing a primary WP code image 1004(1P) in a memory space 941 and storing a backup XY code image 1005(1B) in a memory space 942.

As illustrated in FIG. 10F, XY node 255 has a flash PROM 950 storing a primary XY code image 1005(1P) in a memory space 951 and storing a backup WP code image 1004(1B) in a memory space 952.

It should be noted that primary WP code image 1002(1P) of WP node 52 could be the same data or image as primary WP code image 1004(1P) of WP node 252, assuming that these are identical WP nodes. In a similar manner, backup XY code image 1003(1B) of WP node 52 could be the same data or image as backup XY code image 1005(1B) of WP node 252. In addition, primary WP code images 1002(1P) and/or 1004(1P) could be the same data or image as backup WP code images 1002(1B) and/or 1004(1B).

It should also be noted that primary XY code image 1003(1P) of XY node 55 could be the same data or image as primary XY code image 1005(1P) of XY node 255, assuming that these are identical XY nodes. In a similar manner, backup WP code image 1002(1B) of XY node 55 could be the same data or image as backup WP code image 1004(1B) in of XY node 255. In addition, primary XY code images 1003(1P) and/or 1005(1P) could be the same data or image as backup XY code images 1003(1B) and/or 1005(1B).

In one embodiment, WP code images 1002(1) and WP code images 1004(1) are identical, and/or XY code images 1003(1) and XY code images 1005(1) are identical. In an alternative embodiment, WP code images 1002(1) and WP code images 1004(1) are not identical, and/or XY code images 1003(1) and XY code images 1005(1) are not identical.

Referring to FIG. 9, a stage S802 of flowchart 800 encompasses CP node 50 receiving an electrical communication of a firmware update. The communication may come from an external interface, such as from host 40 through line 80 (FIG. 3). Alternatively, the communication may come from one or more networks or interfaces that connect one or more nodes together, such as bus 60 in FIG. 3. In this case, another node coupled to bus 60 may provide the communication. In another example, bus 60 may be coupled to an external interface (external to library 10) and another computer or controller on that external interface may provide the communication. In any of these examples, any or all nodes may receive the electrical communication of a firmware update. In practice, the present invention does not impose any limitations or any restrictions as to the form of a firmware update file in accordance with the present invention. Thus, the following descriptions of various forms of a firmware update file in accordance with the present invention as illustrated in FIGS. 11A-11D does not limit nor restrict the scope of the various forms of a firmware update file in accordance with the present invention.

FIG. 11A illustrates a firmware update file 1100 in the context where WP code image 1002(1) and WP code image 1004(1) are identical, XY code image 1003(1) and XY code image 1004(1) are identical, and a stage S806 of flowchart 800 is applicable to updating the processor nodes as will be further explained herein. As shown in FIG. 11A, file 1100 includes a sequential ordering of a CP code image 1000(2) as an update to CP code image 1000(1), an OP code image 1001(2) as an update to OP code image 1001(1), a WP code image 1002(2)/1004(2) as an update to WP code image 1002(1) and WP code image 1004(1), and an XY code image 1003(2)/1005(2) as an update to XY code image 1003(1) and XY code image 1005(1).

FIG. 11B illustrates a firmware update file 1101 in the context where WP code image 1002(1) and WP code image 1004(1) are not identical, XY code image 1003(1) and XY code image 1004(1) are not identical, and a stage S806 of flowchart 800 is applicable to updating the processor nodes. As shown in FIG. 11B, file 1101 includes a sequential ordering of CP code image 1000(2) as an update to CP code image 1000(1), OP code image 1001(2) as an update to OP code image 1001(1), a WP code image 1002(2) as an update to WP code image 1002(1), an XY code image 1003(2) as an update to XY code image 1003(1), a WP code image 1004(2) as an update to WP code image 1004(1) and an XY code image 1005(2) as an update to XY code image 1005(1).

FIG. 11C illustrates a firmware update file 1102 in the context where WP code image 1002(1) and WP code image 1004(1) are identical, XY code image 1003(1) and XY code image 1004(1) are identical, and stage S806 of flowchart 800 is not applicable to updating the processor nodes. As shown in FIG. 11C, file 1102 includes a sequential ordering of file 1100, CP code image 1000(2) as an update to CP code image 1000(1), and WP code image 1002(2)/1004(2) as an update to WP code image 1002(1) and WP code image 1004(1).

FIG. 11D illustrates a firmware update file 1103 in the context where WP code image 1002(1) and WP code image 1004(1) are not identical, XY code image 1003(1) and XY code image 1004(1) are not identical, and stage S806 of flowchart 800 is not applicable to updating the processor nodes. As shown in FIG. 11D, file 1103 includes a sequential ordering of file 1101, CP code image 1000(2) as an update to CP code image 1000(1), WP code image 1002(2) as an update to WP code image 1002(1) and WP code image 1004(2) as an update to WP code image 1004(1).

Referring again to FIG. 9, a stage S804 of flowchart 800 encompasses CP node 50 broadcasting the firmware update file (e.g., files 1100, 1101, 1102 and 1103) over the controller area network to all of the processor nodes. In one embodiment, CP node 50 broadcasts the code images of the firmware update file in the same sequential order as received. In an alternative embodiment, CP node 50 reorders the code images of the firmware update file as needed prior to, or during broadcasting the file, in order to ensure a non-disruptive firmware updating of the processor nodes.

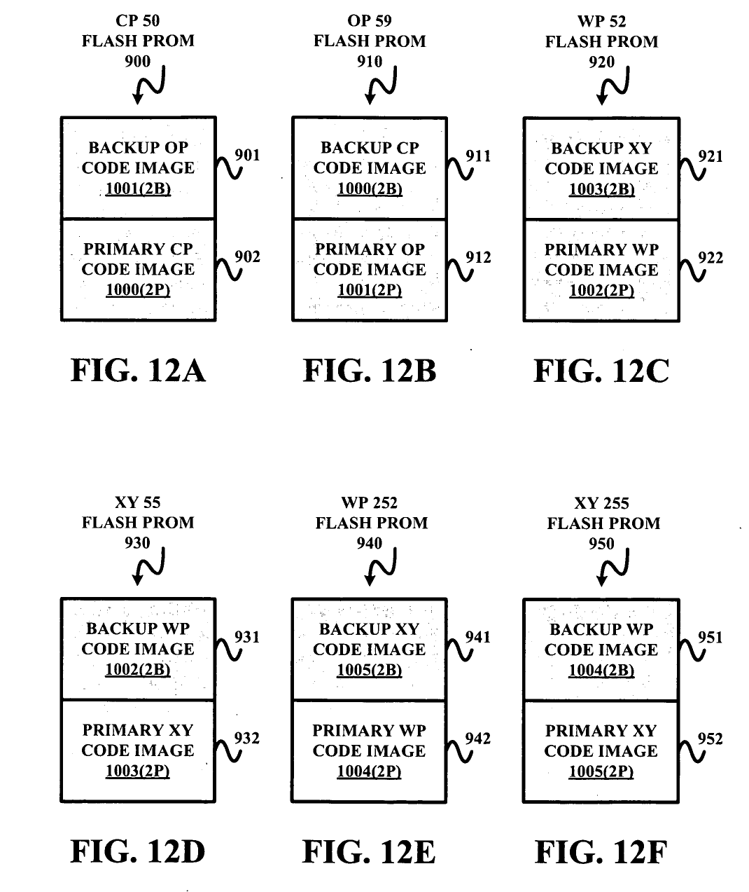

Referring to FIGS. 10A-10F for a description of the contents of the node card flash PROMs before the firmware update, and referring to FIGS. 12A-12F for a description of the contents of the node card flash PROMs after the firmware update, and additionally referring to FIG. 11A, a broadcast of the code images of file 1100 over the CAN bus during stage S804 in the same sequential order as received by CP node 50 involves four (4) broadcasts by CP node 50 followed by an execution of stage S806 of flowchart 800 as described below. Alternatively, it may involve eight (8) broadcasts by CP node 50 without the execution of stage S806 of flowchart 800, also described below.

A broadcast of CP code image 1000(2) over the CAN bus results in a primary CP code image 1000(2P) being written into memory space 902 of flash PROM 900 as illustrated in FIG. 12A. Backup OP code image 1001(1B) previously occupied this memory space as illustrated in FIG. 10A.

A broadcast of OP code image 1001(2) over the CAN results in a primary OP code image 1001(2P) being written into memory space 912 of flash PROM 910 as illustrated in FIG. 12B. Backup CP code image 1000(1B) previously occupied this memory space as illustrated in FIG. 10B.

A broadcast of WP code image 1002(2)/1004(2) over the CAN results in a primary WP code image 1002(2P) being written into memory space 922 of flash PROM 920 as illustrated in FIG. 12C and a primary WP code image 1004(2P) being written into memory space 942 of flash PROM 940 as illustrated in FIG. 12E. Backup XY code image 1003(1B) and backup XY code image 1005(1B) previously occupied these memory spaces as illustrated in FIGS. 10C and 10E.

A broadcast of XY code image 1003(2)/1005(2) over the CAN results in a primary XY code image 1003(2P) being written into memory space 932 of flash PROM 930 as illustrated in FIG. 12D and a primary XY code image 1005(2P) being written into memory space 952 of flash PROM 950 as illustrated in FIG. 12F. Backup WP code image 1002(1B) and backup WP code image 1004(1B) previously occupied these memory spaces as illustrated in FIGS. 10D and 10F.

At this point, all of the primary code images have been successfully updated by writing over the memory occupied by backup code images for other nodes. This was done in such a way that any disruption to the library firmware update would not have resulted in an outage or repair action, because there was always an operable primary code image for every node. The backup code images may be updated by broadcasting firmware update file 1100 a second time, thereby properly storing backup code images in accordance with flowchart 700 (FIG. 7). In addition, the firmware update file may contain redundant code images to complete the firmware update of the backup code images. For example, the firmware update file may be comprised of two firmware update files 1100 back-to-back, such that the first firmware update file 1100 updates each of the primary code images and the second firmware update file 1100 updates each of the backup code images. An alternative approach could comprise the processor nodes executing a redundant firmware update method for a distributed control system as disclosed in coassigned U.S. Patent Application Publication No. 2004/0139294 A1, filed Jan. 14, 2003, and published Jul. 15, 2004, which is incorporated herein by reference in its entirety. In this case, each node may request a copy of another nodes primary code image, to be used as a backup code image for that node, as will be discussed.

At optional stage S806, the library 10 uses the primary code images to create or store the backup code images. This may be done during the firmware update, after the firmware update, after a power-on or reset of the library, after a power-on or reset of one or more individual nodes, as directed by an operator, as directed by another computer or controller, automatically by the library, etc. In one embodiment, the backup images are created or copied after a reset of the library, or individual nodes, to activate the firmware update of the backup code images. The following is an example of how the backup code images may be obtained by each node requiring an update of its backup code image. A request by CP node 50 to OP node 59 for primary OP code image 1001(2P) results in primary OP code image 1001(2P) being written as backup OP code image 1001(2B) in memory space 901 of flash PROM 900 as illustrated in FIG. 12A. Primary CP code image 1000(1P) previously occupied this memory space as illustrated in FIG. 10A.

A request by OP node 59 to CP node 50 for primary CP code image 1000(2P) results in primary CP code image 1000(2P) being written as backup CP code image 1000(2B) in memory space 911 of flash PROM 910 as illustrated in FIG. 12B. Primary OP code image 1001(1P) previously occupied this memory space as illustrated in FIG. 10B.

A request by WP node 52 to XY node 55 for primary XY code image 1003(2P) results in primary XY code image 1003(2P) being written as backup XY code image 1003(2B) in memory space 921 of flash PROM 920 as illustrated in FIG. 12C. Primary WP code image 1002(1P) previously occupied this memory space as illustrated in FIG. 10C.

A request by XY node 55 to WP node 52 for primary WP code image 1002(2P) results in primary WP code image 1002(2P) being written as backup WP code image 1002(2B) in memory space 931 of flash PROM 930 as illustrated in FIG. 12D. Primary XY code image 1003(1P) previously occupied this memory space as illustrated in FIG. 10D.

A request by WP node 252 to XY node 255 for primary XY code image 1005(2P) results in primary XY code image 1005(2P) being written as backup XY code image 1005(2B) in memory space 941 of flash PROM 940 as illustrated in FIG. 12E. Primary WP code image 1004(1P) previously occupied this memory space as illustrated in FIG. 10E. Alternatively, if XY code image 1003(2P) and XY code image 1005(2P) are the same, as discussed above, WP node 252 could receive the same broadcast of primary XY code image 1003(2P) that resulted from the request of WP node 52 to XY node 55 above. This would eliminate the need to send a separate XY code image 1005(2P).

A request by XY node 255 to WP node 252 for primary WP code image 1004(2P) results primary WP code image 1004(2P) being written as backup WP code image 1004(2B) in memory space 951 of flash PROM 950 as illustrated in FIG. 12F. Primary XY code image 1005(1P) previously occupied this memory space as illustrated in FIG. 10F. Alternatively, if WP code image 1002(2P) and WP code image 1004(2P) are the same, as discussed above, XY node 255 could receive the same broadcast of primary WP code image 1002(2P) that resulted from the request of XY node 55 to WP node 52 above. This would eliminate the need to send a separate WP code image 1004(2P).

It should be noted that this method of synchronizing backup copies of code images does not need to be request based, but instead could be command based. For example, a node may recognize that there is no backup code image in the library and it could direct another node to save its primary code image as a backup image. In another example, another node, computer, human, etc. may direct the synchronization of the backup code images.

Referring to FIGS. 10A-10F for a description of the contents of the node card flash PROMs before the firmware update, and referring to FIGS. 12A-12F for a description of the contents of the node card flash PROMs after the firmware update, and additionally referring to FIG. 11B, a broadcast of the code images of file 1101 over the CAN during stage S804 in the same sequential order as received by CP node 50 involves six (6) broadcasts by CP node 50 followed by an execution of stage S806 of flowchart 800 as described below. Alternatively, it may involve twelve (12) broadcasts by CP node 50 without the execution of stage S806 of flowchart 800, also described below.

A broadcast of CP code image 1000(2) over the CAN results in a primary CP code image 1000(2P) being written into memory space 902 of flash PROM 900 as illustrated in FIG. 12A. Backup OP code image 1001(1B) previously occupied this memory space as illustrated in FIG. 10A.

A broadcast of OP code image 1001(2) over the CAN results in a primary OP code image 1001(2P) being written into memory space 912 of flash PROM 910 as illustrated in FIG. 12B. Backup CP code image 1000(1B) previously occupied this memory space as illustrated in FIG. 10B.

A broadcast of WP code image 1002(2) over the CAN results in a primary WP code image 1002(2P) being written into memory space 922 of flash PROM 920 as illustrated in FIG. 12C. Backup XY code image 1003(1B) previously occupied this memory space as illustrated in FIG. 10C.

A broadcast of XY code image 1003(2) over the CAN results in a primary XY code image 1003(2P) being written into memory space 932 of flash PROM 930 as illustrated in FIG. 12D. Backup WP code image 1002(1B) previously occupied this memory space as illustrated in FIG. 10D.

A broadcast of WP code image 1004(2) over the CAN results in a primary WP code image 1004(2P) being written into memory space 942 of flash PROM 940 as illustrated in FIG. 12E. Backup XY code image 1005(1B) previously occupied this memory space as illustrated in FIG. 10E.

A broadcast of XY code image 1005(2) over the CAN results in a primary XY code image 1005(2P) being written into memory space 952 of flash PROM 950 as illustrated in FIG. 12F. Backup WP code image 1004(1B) previously occupied this memory space as illustrated in FIG. 10F.

Thereafter, the firmware update file 1101 and/or its component code images are sent or broadcast a second time, or the processor nodes execute the redundant firmware update method, to thereby properly store backup code images in accordance with flowchart 700 (FIG. 7) as previously described herein in connection with firmware update file 1100.

Referring to FIGS. 10A-10F for a description of the contents of the node card flash PROMs before the firmware update, and referring to FIGS. 12A-12F for a description of the contents of the node card flash PROMs after the firmware update, and additionally referring to FIG. 11C, a broadcast of the code images of file 1102 over the CAN bus during stage S804 in the same sequential order as received by CP node 50 involves six (6) broadcasts by CP node 50 that is not followed by an execution of stage S806 of flowchart 800.

A first broadcast of CP code image 1000(2) over the CAN results in a primary CP code image 1000(2P) being written into memory space 902 of flash PROM 900 as illustrated in FIG. 12A. Backup OP code image 1001(1B) previously occupied this memory space as illustrated in FIG. 10A.

A broadcast of OP code image 1001(2) over the CAN results in a backup OP code image 1001(2B) being written into memory space 901 of flash PROM 900 as illustrated in FIG. 12A, and a primary OP code image 1001(2P) being written into memory space 912 of flash PROM 910 as illustrated in FIG. 12B. Primary CP code image 1000(1P) and backup CP code image 1000(1B) previously occupied these memory spaces as illustrated in FIGS. 10A and 10B. The backup OP code image 1001(2B) is updated at this time because the primary CP code image 1000(2P) has already been successfully updated, thereby preserving the “fail safe” nature of the firmware update.

A broadcast of WP code image 1002(2)/1004(2) over the CAN bus results in a primary WP code image 1002(2P) being written into memory space 922 of flash PROM 920 as illustrated in FIG. 12C, and a primary WP code image 1004(2P) being written into memory space 942 of flash PROM 940 as illustrated in FIG. 12E. Backup XY code image 1003(1B) and backup XY code image 1005(1B) previously occupied these memory spaces as illustrated in FIGS. 10C and 10E.

A broadcast of XY code image 1003(2)/1005(2) over the CAN bus results in a backup XY code image 1003(2B) being written in memory space 921 of flash PROM 920 as illustrated in FIG. 12C, primary XY code image 1003(2P) being written into memory space 932 of flash PROM 930 as illustrated in FIG. 12D, backup XY code image 1005(2B) being written in memory space 941 of flash PROM 940 as illustrated in FIG. 12E, and primary XY code image 1005(2P) being written into memory space 952 of flash PROM 950 as illustrated in FIG. 12F. Primary WP code image 1002(1P), backup WP code image 1002(1B), primary WP code image 1004(1P), and backup WP code image 1004(1B) previously occupied these memory spaces as illustrated in FIGS. 1C, 10D, 10E, and 10F. The backup XY code images 1003(2B) and 1005(2B) are updated at this time because the primary WP code images 1002(2P) and 1004(2P) have already been successfully updated, thereby preserving the “fail safe” nature of the firmware update.

A second broadcast of CP code image 1000(2) over the CAN results in a backup code image 1000(2B) being written into memory space 911 of flash PROM 910 as illustrated in FIG. 12B. Primary OP code image 1001(1B) previously occupied this memory space as illustrated in FIG. 10B.

A second broadcast of WP code image 1002(2)/1004(2) over the CAN results in backup WP code image 1002(2B) being written into memory space 931 of flash PROM 930 as illustrated in FIG. 12D, and a backup WP code image 1004(2B) being written into memory space 951 of flash PROM 950 as illustrated in FIG. 12F. Primary XY code image 1003(1P) and primary XY code image 1005(1P) previously occupied these memory spaces as illustrated in FIGS. 10D and 10F.

In the example of FIG. 11C, there is no need to send duplicate firmware update files 1102, 1101, or 1100 because only one additional CP code image and one additional WP code image was required to complete the code update of the primary and backup code images. In addition, the example of FIG. 11C also eliminates the need for the nodes to execute the redundant firmware update method described above. As compared to FIG. 11A and the accompanying description, FIG. 11C effectively eliminates the need to resend an additional OP code image and an additional XY code image, thereby saving firmware update time and duplication of data over the CAN bus.

Referring to FIGS. 10A-10F for a description of the contents of the node card flash PROMs before the firmware update, and referring to FIGS. 12A-12F for a description of the contents of the node card flash PROMs after the firmware update, and additionally referring to FIG. 11D, a broadcast of the code images of file 1103 over the CAN bus during stage S804 in the same sequential order as received by CP node 50 involves seven (9) broadcasts by CP node 50 that is not followed by an execution of stage S806 of flowchart 800.

A first broadcast of CP code image 1000(2) over the CAN bus results in a primary CP code image 1000(2P) being written into memory space 902 of flash PROM 900 as illustrated in FIG. 12A. Backup OP code image 1001(1B) previously occupied this memory space as illustrated in FIG. 10A.

A broadcast of OP code image 1001(2) over the CAN results in a backup OP code image 1001(2B) being written into memory space 901 of flash PROM 900 as illustrated in FIG. 12A and a primary OP code image 1001(2P) being written into memory space 912 of flash PROM 910 as illustrated in FIG. 12B. Primary CP code image 1000(1P) and backup CP code image 1000(1B) previously occupied these memory spaces as illustrated in FIGS. 10A and 10B.

A first broadcast of WP code image 1002(2) over the CAN results in a primary WP code image 1002(2P) being written into memory space 922 of flash PROM 920 as illustrated in FIG. 12C. Backup XY code image 1003(1B) previously occupied this memory space as illustrated in FIG. 10C.

A broadcast of XY code image 1003(2) over the CAN results in a backup XY code image 1003(2B) being written in memory space 921 of flash PROM 920 as illustrated in FIG. 12C and a primary XY code image 1003(2P) being written into memory space 932 of flash PROM 930 as illustrated in FIG. 12D. Primary WP code image 1002(1P) and backup WP code image 1002(1B) previously occupied these memory spaces as illustrated in FIGS. 10C and 10D.

A first broadcast of WP code image 1004(2) over the CAN results in a primary WP code image 1004(2P) being written into memory space 942 of flash PROM 940 as illustrated in FIG. 12E. Backup XY code image 1005(1B) previously occupied this memory space as illustrated in FIG. 10E.

A broadcast of XY code image 1005(2) over the CAN results in a backup XY code image 1005(2B) being written in memory space 941 of flash PROM 940 as illustrated in FIG. 12E, and a primary XY code image 1005(2P) being written into memory space 952 of flash PROM 950 as illustrated in FIG. 12F. Primary WP code image 1004(1P) and backup WP code image 1004(1B) previously occupied these memory spaces as illustrated in FIGS. 10E and 10F.

A second broadcast of CP code image 1000(2) over the CAN results in a backup code image 1000(2B) being written into memory space 911 of flash PROM 910 as illustrated in FIG. 12B. Primary OP code image 1001(1P) previously occupied this memory space as illustrated in FIG. 10B.

A second broadcast of WP code image 1002(2) over the CAN results in a backup WP code image 1002(2B) being written into memory space 931 of flash PROM 930 as illustrated in FIG. 12D. Primary XY code image 1003(1P) previously occupied this memory space as illustrated in FIG. 10D.

A second broadcast of WP code image 1004(2) over the CAN results in a backup WP code image 1004(2B) being written into memory space 951 of flash PROM 950 as illustrated in FIG. 12F. Primary XY code image 1005(1P) previously occupied this memory space as illustrated in FIG. 10F.

Referring again to FIG. 9, upon a successful execution of stage S804 and/or S806, an optional stage S808 encompasses a reset of the library or a reset of one or more nodes within the library. This provides a method of activating the new library firmware that was just updated. A reset may comprise an electrical reset, software reset, hardware or software interrupt, a software branch, jump, or call, etc. This stage may be controlled by one or more nodes within the library, as part of the library firmware update process. Alternatively, this stage may occur through operator intervention, for example, by making a selection at on operator panel or other user interface, or by power cycling the library, etc. Still further, this stage may occur as the result of the next library power-on or as the result of a library component replacement. For example, a library power-on may appear as a reset to some or all of the nodes in the library. In another example, a component replacement of a node card would result in a reset of that node card and/or the entire library.

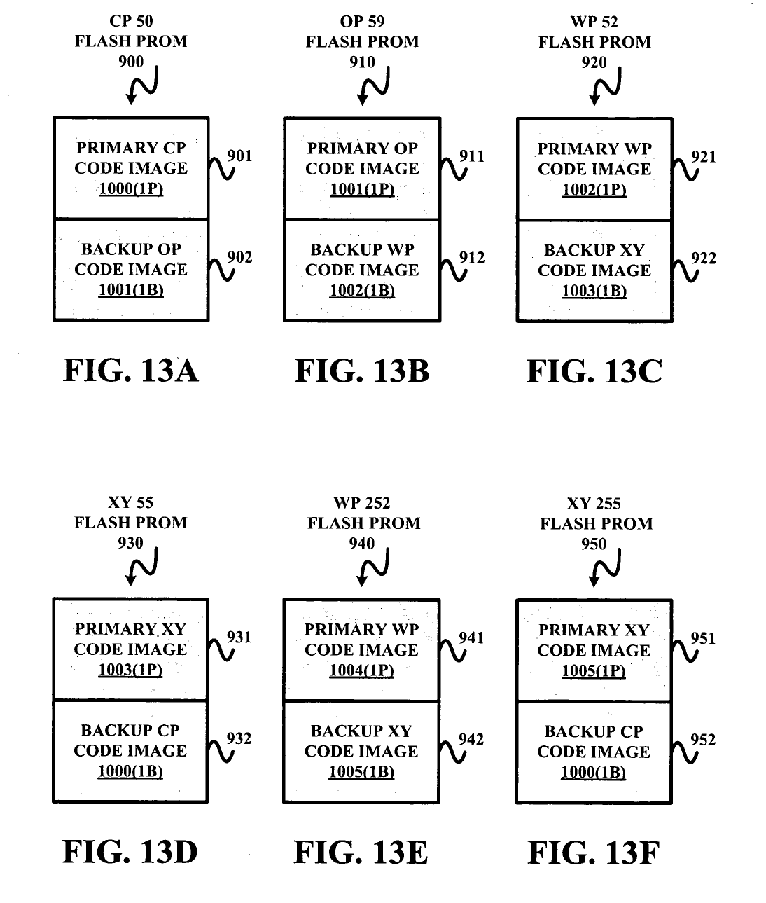

To facilitate a further understanding of the firmware update file broadcast method of the present invention, flowchart 800 will now be described in the context of a backup shifting arrangement of nodes 50, 52, 59, 55, 252 and 255 as illustrated in FIGS. 13A-13F storing a CP code image 1000(1), an OP code image 1001(1), a WP code image 1002(1), an XY code image 1003(1), a WP code image 1004(1) and an XY code image 1005(1) prior to the execution of flowchart 800.

As illustrated in FIG. 13A, CP node 50 has flash PROM 900 storing a primary CP code image 1000(1P) in memory space 901 and storing a backup OP code image 1001(1B) in memory space 902.

As illustrated in FIG. 13B, OP node 59 has flash PROM 910 storing a primary OP code image 1001(1P) in a memory space 911 and storing a backup WP code image 1002(1B) in memory space 912.

As illustrated in FIG. 13C, WP node 52 has flash PROM 920 storing a primary WP code image 1002(1P) in memory space 921 and storing a backup XY code image 1003(1B) in memory space 922.

As illustrated in FIG. 13D, XY node 55 has flash PROM 930 storing a primary XY code image 1003(1P) in memory space 931 and storing a backup CP code image 1000(1B) in memory space 932.

As illustrated in FIG. 13E, WP node 252 has flash PROM 940 storing a primary WP code image 1004(1P) in memory space 941 and storing a backup XY code image 1005(1B) in memory space 942.

As illustrated in FIG. 13F, XY node 255 has flash PROM 950 storing a primary XY code image 1005(1P) in memory space 951 and storing a backup CP code image 1000(1B) in memory space 952.

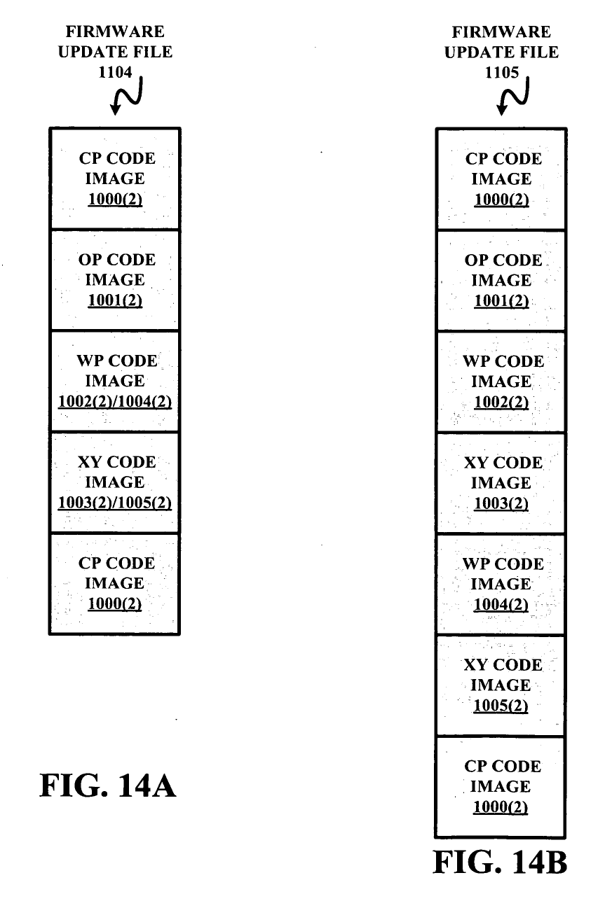

Referring to FIG. 9, as previously stated herein, stage S802 of flowchart 800 encompasses CP node 50 receiving an electrical communication of a firmware update file. There may be a number of different sources of the electrical communication, as discussed above. Again, in practice, the present invention does not impose any limitations or any restrictions as to the form of a firmware update file in accordance with the present invention. Thus, the following descriptions of various forms of a firmware update file in accordance with the present invention as illustrated in FIGS. 14A and 14B does not limit nor restrict the scope of the various forms of a firmware update file in accordance with the present invention.

FIG. 14A illustrates a firmware update file 1104 in the context where WP code image 1002(1) and WP code image 1004(1) are identical, XY code image 1003(1) and XY code image 1004(1) are identical, and stage S806 of flowchart 800 is not applicable to updating the processor nodes. As shown in FIG. 14A, file 1104 includes a first copy of CP code image 1000(2) as an update to CP code image 1000(1), OP code image 1001(2) as an update to OP code image 1001(1), WP code image 1002(2)/1004(2) as an update to WP code image 1002(1) and WP code image 1004(1), XY code image 1003(2)/1005(2) as an update to XY code image 1003(1) and XY code image 1005(1), and a second copy of CP code image 1000(2) as an update to CP code image 1000(1).

FIG. 14B illustrates a firmware update file 1104 in the context where WP code image 1002(1) and WP code image 1004(1) are not identical, XY code image 1003(1) and XY code image 1004(1) are not identical, and stage S806 of flowchart 800 is not applicable to updating the processor nodes. As shown in FIG. 14B, file 1105 includes a first copy of CP code image 1000(2) as an update to CP code image 1000(1), OP code image 1001(2) as an update to OP code image 1001(1), WP code image 1002(2) as an update to WP code image 1002(1), XY code image 1003(2) as an update to XY code image 1003(1), WP code image 1004(2) as an update to WP code image 1004(1), XY code image 1005(2) as an update to XY code image 1005(1), and a second copy of CP code image 1000(2) as an update to CP code image 1000(1).

Referring again to FIG. 9, as previously described herein, stage S804 of flowchart 800 encompasses CP node 50 broadcasting the firmware update file (e.g., files 1104 and 1105) over the controller area network to all of the processor nodes. Again, in one embodiment, CP node 50 broadcast the code images of the firmware update file in the same sequential order as received, and in an alternative embodiment, CP node 50 reorders the code images of the firmware update file as needed prior to broadcasting the file in order to ensure a non-disruptive firmware updating of the processor nodes.

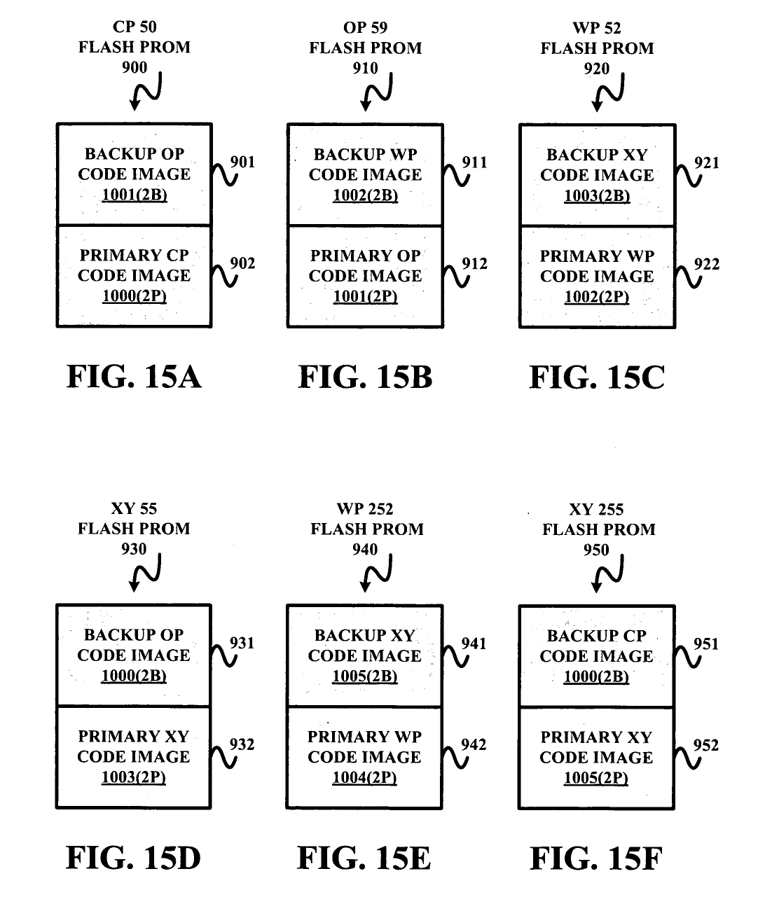

Referring to FIGS. 13A-13F for a description of the contents of the node card flash PROMs before the firmware update, and referring to FIGS. 15A-15F for a description of the contents of the node card flash PROMs after the firmware update, and additionally referring to FIG. 14A, a broadcast of the code images of file 1104 over the CAN bus during stage S804 in the same sequential order as received by CP node 50 effectively involves five (5) broadcasts by CP node 50 that is not followed by an execution of stage S806 of flowchart 800.

A first broadcast of CP code image 1000(2) over the CAN bus results in a primary CP code image 1000(2P) being written into memory space 902 of flash PROM 900 as illustrated in FIG. 15A. Backup OP code image 1001(1B) previously occupied this memory space as illustrated in FIG. 13A.

A broadcast of OP code image 1001(2) over the CAN bus results in a primary OP code image 1001(2P) being written into memory space 912 of flash PROM 910 as illustrated in FIG. 15B and a backup OP code image 1001(2B) being written into memory space 901 of flash PROM 900 as illustrated in FIG. 15A. Backup WP code image 1002(1B) and primary CP code image 1000(1P) previously occupied these memory spaces as illustrated in FIGS. 13B and 13A.

A broadcast of WP code image 1002(2)/1004(2) over the CAN bus results in a primary WP code image 1002(2P) being written into memory space 922 of flash PROM 920 as illustrated in FIG. 15C, a backup WP code image 1002(2B) being written into memory space 911 of flash PROM 910 as illustrated in FIG. 15B, and a primary WP code image 1004(2P) being written into memory space 942 of flash PROM 940 as illustrated in FIG. 15E. Backup XY code image 1003(1B), primary OP code image 1001(1P), and backup XY code image 1005(1B) previously occupied these memory spaces as illustrated in FIGS. 13C, 13B and 13E.

A broadcast of XY code image 1003(2)/1005(2) over the CAN bus results in a backup XY code image 1003(2B) being written into memory space 921 of flash PROM 920 as illustrated in FIG. 15C, a primary XY code image 1003(2P) being written into memory space 932 of flash PROM 930 as illustrated in FIG. 15D, a backup XY code image 1005(2B) being written into memory space 941 of flash PROM 940 as illustrated in FIG. 15E, and a primary XY code image 1005(2P) being written into memory space 952 of flash PROM 950 as illustrated in FIG. 15F. Primary WP code image 1002(1P), backup CP code image 1000(1B), primary WP code image 1004(1P), and backup CP code image 1000(1B) previously occupied these memory spaces as illustrated in FIGS. 13C, 13D, 13E, and 13F.

A second broadcast of CP code image 1000(2) over the CAN results in a backup CP code image 1000(2B) being written into memory space 931 of flash PROM 930 and a backup CP code image 1000(2B) being written into memory space 951 of flash PROM 950 as illustrated in FIGS. 15D and 15F. Primary XY code image 1005(1P) and primary XY code image 1005(1P) previously occupied these memory spaces as illustrated in FIGS. 13D and 13F.

From the above example, it can be seen that maximum efficiency is gained by ordering the code images in such a way as to minimize the duplication of sending code images. In this example, only a single code image must be sent a second time to complete the update of all primary code images and all backup code images. The additional code image could be sent as part of the firmware update, as described above, or it could be sent by implementing the redundant firmware update method of stage S806 of flowchart 800, as described above with reference to FIG. 11.

Referring to FIG. 14B, a broadcast of the code images of file 1105 over the CAN bus during stage S804 in the same sequential order as received by CP node 50 involves seven (7) broadcasts by CP node 50 that is not followed by an execution of stage S806 of flowchart 800. Sufficient examples have been provided such that a detailed description of the firmware update process involving FIG. 14B will be omitted.

Referring again to FIG. 9, upon a successful execution of stage S804 and/or S806, an optional stage S808 encompasses a reset of the library or a reset of one or more nodes within the library, as discussed above.

While the broadcast of individual code images have been described for the update of primary and/or backup code images, this was done to simplify the description of the invention and is not meant to limit the invention to the distribution of individual code images. In fact, the code images may be part of a larger structure with no apparent delineation between each code image. For example, firmware update file 1104 of FIG. 14A may be seen as a continuous data stream where each node picks up the portion of the data stream required for its primary and/or backup code image.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by a processor to perform operations for a redundant firmware update of a processor node in a distributed control system, the operations comprising:
storing a first primary code image in a first memory space and storing a first backup code image in a second memory space prior to receiving an electrical communication of a second primary code image as an update of the first primary code image; and
storing the second primary code image in the second memory space and storing a second backup code image in the first memory space, wherein the second primary code image is written into the second memory space prior to the second backup code image being written into the first memory space.

2. The signal bearing medium of claim 1, wherein the second backup code image is electrically communicated as a copy of the first backup code image.

3. The signal bearing medium of claim 1, wherein the second backup code image is electrically communicated as an update of a third primary code image of another processor node.

4. The signal bearing medium of claim 1, wherein the electrical communication of the second primary code image is received prior to receiving and electrical communication of the second backup code image.

5. The signal bearing medium of claim 1, wherein receiving an electrical communication of the second backup code image is prohibited prior to the electrical communication of the second primary code image being received.

6. The signal bearing medium of claim 1, wherein receiving an electrical communication of the second backup code image is prohibited prior to the second primary code image being written into the second memory space.

7. The signal bearing medium of claim 1, wherein the first memory space and second memory space are located within at least one non-volatile memory including at least one of an electrically erasable programmable read only memory, a flash programmable read only memory, a battery backup random access memory, and a hard disk drive.

8. A processor node in a distributed control system, the processor node comprising:
a processor;
a memory operable to store instructions operable with the processor for a redundant firmware update of the processor node in the distributed control system, the instructions being executable for:
storing a first primary code image in a first memory space and storing a first backup code image in a second memory space prior to receiving an electrical communication of a second primary code image as an update of the first primary code image; and
storing the second primary code image in the second memory space and storing a second backup code image in the first memory space, wherein the second primary code image is written into the second memory space prior to the second backup code image being written into the first memory space.

9. The processor node of claim 8, wherein the second backup code image is electrically communicated to the processor node as a copy of the first backup code image.

10. The processor node of claim 8, wherein the second backup code image is electrically communicated as an update of a third primary code image of another processor node.

11. The processor node of claim 8, wherein the electrical communication of the second primary code image is received by the processor node prior to receiving an electrical communication of the second backup code image.

12. The processor node of claim 8, wherein receiving an electrical communication of the second backup code image is prohibited prior to the electrical communication of the second primary code image being received.

13. The processor node of claim 8, wherein receiving an electrical communication of the second backup code image is prohibited prior to the second primary code image being written into the second memory space.

14. The processor node of claim 8, wherein the first memory space and second memory space are located within at least one non-volatile memory including at least one of an electrically erasable programmable read only memory, a flash programmable read only memory, a battery backup random access memory, and a hard disk drive.

15. A method for a redundant firmware update of a processor node in a distributed control system, the method comprising:
storing a first primary code image in a first memory space of and a first backup code image in a second memory space prior to receiving an electrical communication of a second primary code image as an update of the first primary code image; and
storing a second backup code image in the first memory space and storing a second primary code image in the second memory space in response to receiving the electrical communication of the second primary code image as the update of the first primary code image and receiving an electrical communication of the second backup code image,
wherein the second primary code image is written into the second memory space prior to the second backup code image being written into the first memory space.

16. The method of claim 15, wherein the second backup code image is electrically communicated as a copy of the first backup code image.

17. The method of claim 15, wherein the second backup code image is electrically communicated as an update of a third primary code image of another processor node.

18. The method of claim 15, wherein the electrical communication of the second primary code image is received prior to receiving an electrical communication of the second backup code image.

19. The method of claim 15, wherein receiving an electrical communication of the second backup code image is prohibited prior to the electrical communication of the second primary code image being received.

20. The method of claim 15, wherein receiving an electrical communication of the second backup code image is prohibited prior to the second primary code image being written into the second memory space.
